(19) United States
(12) Patent Application Publication
(10) Pub. No.: US 2003/0061111 A1
(43) Pub. Date: Mar. 27, 2003

(54) Method and system for parent controlled e-commerce

(75) Inventors: Rabindranath Dutta, Austin, TX (US); Ramamoorthy Karthikeyan, Austin, TX (US)

Correspondence Address: STREETS & STEELE, 13831 NORTHWEST FREEWAY, SUITE 355, HOUSTON, TX, 77040, US

(73) Assignee: INTERNATIONAL BUSINESS MACHINES CORPORATION, ARMONK, NY

(21) Appl. No.: 09/963,715

(22) Filed: Sep. 26, 2001

(51) Int. Cl. G06F 17/60

(52) U.S. Cl. 705/26

(57) ABSTRACT

A method, computer system and computer program product for providing a parent with electronic control over e-transactions proposed by a minor for whom the parent is responsible. The method includes electronically providing information describing the proposed e-transaction to the parent and electronically receiving information from the parent disposing of some or all of the proposed e-transaction.

### BACKGROUND OF THE INVENTION

1. Field of the Invention

The present invention relates to methods and systems for entering e-commerce transactions.

2. Description of the Related Art

The spending power of the average teenager is at its highest point in history. In general, minors, or persons under 18 years of age, direct their increasing spending power toward consumer transactions of many kinds, including transaction using the internet (“e-commerce”). Each day, thousands of minors use computers to access the numerous goods and services available through the internet. As the scope of all goods and services available over the internet increases, an increasing number of goods and services specifically targeted for purchase by minors will become available. However, legal and practical limitations on the capacity of minors to purchase goods or services using the internet prevents or inhibits many minors from participating in e-commerce.

“E-commerce,” which in this context means the purchase of goods or services by a purchaser using the internet (an “e-purchaser”), often involves the submission of an e-purchaser's name, credit card number and credit card expiration date in order to complete a transaction using the internet (an “e-transaction”). “E-goods” and “e-services” are goods and services that may be advertised, marketed or sold over the internet by online retailers, often referred to as “e-tailers”.

Online content that is accessible through the internet, often referred to as “e-content”, takes many forms. From a retail perspective, e-goods and e-services can be ordered through the internet, purchased through the internet, and in some cases, even delivered through the internet via downloading (e.g., computer software, e-music, e-books, advertising, educational literature, news and online catalogs, etc.) or through e-access (e.g., restricted or controlled access websites, e-games, e-chat rooms, on-line dating services, etc.). Many e-goods available on the internet use conventional means of delivering e-goods to the customer (e.g., customer pick-up, express mail, postal service or parcel delivery services). Other e-goods may require related e-services to be performed at customer-specified locations (e.g., e-groceries or e-flowers requiring delivery to the customer or designated recipient). As the scope of e-goods and eservices that can be ordered and purchased over the internet expands, it becomes increasingly more important to overcome the legal and practical barriers that prevent minors from safe, efficient and supervised use of the internet to efficiently and conveniently order and purchase e-goods and e-services.

Some of the barriers to minors' participation in e-commerce serve an important purpose, since not all e-content available through the internet is appropriate for minors. Without proper safeguards, the internet could potentially provide minors with access to tobacco products and firearms, and exposure to undesirable content and the like. There is a wide variety of e-goods and e-services that are inappropriate for minors, but which are available to anyone with a credit card number and access to the internet.

Most e-transactions are enabled using credit card information transmitted over the internet to the e-tailer, usually using programs for secured or encrypted transmission of this and other personal information. A parent may choose not to provide a minor with credit card information for a variety of reasons. Minors may be more likely to misuse credit cards, and become victims to unscrupulous persons using the internet to obtain credit card information for improper and unauthorized uses. Minors may also be far less likely than their parents to detect a scam or heed to warnings by consumer watchdog groups that report such scams to consumers.

Parents may choose to contemporaneously monitor each e-transaction proposed by a minor. In order to prevent access to inappropriate e-content, parents may supervise their minors' transactions and either authorize or refuse to authorize purchases proposed by the minor. This supervision usually involves the parent reviewing the minor's proposed e-transaction using the same computer used by the minor to locate the desired e-goods or e-services. If the parent reviews and approves the proposed e-transaction, the parent may then enable the e-transaction by using the same computer to transmit credit card information to the e-tailer over the internet. For example, parents who wish to prevent their minor children from purchasing or downloading objectionable music may require their minor to request that the parent come sit at the computer to review the minor's proposed e-transaction and, if the parent is satisfied that the minor should receive the e-goods made the subject of the proposed e-transaction, the parent may enter their credit card information thereby enabling the e-transaction. In this “hands-on” way, parents may effectively prevent minors from using the internet to access inappropriate material or to prevent minors from entering into e-transactions involving high costs or future purchases that may substantially inflate the cost of the proposed e-transaction.

While direct or contemporaneous e-commerce supervision of minors is effective, it can also be very inconvenient. First, it requires the supervising parent to be personally available in the presence of the minor to review the proposed e-transaction using the same computer used by the minor to locate the desired e-goods or e-services. Second, the supervising parent may not have enough time to fully research the proposed e-transaction, possibly resulting in poor or uninformed decisions. Without the time to consult various watchdog groups or review services, the parent may enable e-transactions that, but for the lack of time, the parent would have determined to be inappropriate. Third, the credit card information may be transmitted by the approving parent in the presence of the minor, and the risk of inadvertently sharing the credit card information with the minor threatens the goal of the parent's review of the minor's proposed e-transactions. For these and other reasons, a parent that is otherwise eager to provide a minor with access to the resources available through the internet may refrain from providing the minor with access to e-commerce.

Another major problem preventing more participation in e-commerce by minors is that, in most places, a minor is legally incompetent to enter into a binding contract, whether the contract is made using the internet or conventional written documents. These laws are based on the notion that minors lack sufficient maturity, experience and good judgment to enable them to make reasonable decisions regarding contracts. As a result, many e-tailers will refuse to enter into e-transactions with minors, and many providers of goods and services that are wholly appropriate for minors cannot exploit the internet to advertise, market and sell to minors. Thus, many potentially beneficial e-transactions involving minors are prevented, and the advantages provided by e-comrnerce are denied to minors and, in turn, to their parents.

What is needed is a method of using the internet to overcome the barriers that prevent expanded e-commerce with minors. What is needed is a method of enabling a parent to freely and conveniently review information describing an e-transaction proposed by a minor over whom the parent has control. What is needed is a method of enabling a parent to monitor and selectively authorize e-transactions proposed by a minor without having to be physically present with the minor to review the e-transaction at the time it is proposed. What is needed is a method of preventing unwanted access by others to credit card information that may be used to enable e-transactions. What is needed is a method of providing a parent with the opportunity to selectively authorize or reject all or a part of electronic transactions proposed by a minor over whom the parent has control. What is needed is a system for providing a parent with a convenient method of reviewing e-transactions proposed by a minor and tracking a minor's proposed and completed e-transactions.

### SUMMARY OF THE INVENTION

The present invention facilitates a parent's oversight and supervision of a minor for whom the parent is responsible. Although our traditional notion of a parent and a minor is in the context of a parent and a child, the present invention is equally applicable to facilitating control of e-transactions by a parent, guardian, trustee or custodian having authority over transactions of a child, ward, minor, dependent or infant. However, the present invention has other uses in many other contexts where the relationship of one party to another involves supervision or authorization. For example, an authorizing physician may use the present invention to oversee and supervise a patient's or a subordinate's (e.g., an intern, resident or nurse) attempts to electronically order, obtain or prescribe treatments or medications for a patient; a teacher may use the present invention to oversee and supervise a student's or a teaching assistant's attempts to electronically enter or check answers to a test or to electronically enter or modify grades or test scores; a trustee may use the present invention to oversee and supervise proposed e-transactions by a senior citizen in their care; an attorneys' client may use the present invention to oversee and supervise an attorney's proposed expenditures on behalf of the client to pay for expert services, filing fees, legal fees or legal transcripts; and, a spouse having primary responsibility for managing family finances may use the present invention to authorize e-transactions (e-securities transactions, e-loans, e-transactions) proposed by the other spouse. For purposes of describing the present invention, the term “proposing party” is used to refer to any proposing party such as a minor child, dependant, patient, intern, assistant, student, senior, attorney, client or any party that may propose an e-transaction, but that requires the authorization of an authorizing party to complete the e-transaction. Likewise, the term “authorizing party” is used to refer to any authorizing party such as a parent, guardian, trustee, custodian, physician, client, teacher, spouse or any other party that has authority to approve or reject an e-transaction proposed by a proposing party for whom they are responsible in some context relevant to the proposed e-transaction.

The present invention provides a method for an authorizing party to electronically review and provide authorization of e-transactions proposed by a proposing party. The present invention provides a method for enabling a parent to review and either authorize or reject each discrete part or all parts of an e-commerce transaction proposed by a minor.

The present invention requires submission of the parent's e-mail address either to the e-tailer involved in the proposed e-transaction, or to an independent third-party or agent that facilitates the e-transaction. The third party may obtain the authorizing party's e-mail address at the same time that it receives information regarding the proposed e-transaction and, upon obtaining authorization or credit card information from the authorizing party, provide the e-tailer with the credit card information needed to enable the proposing party's proposed e-transaction. The authorizing party's e-mail address may be submitted to the e-tailer or to the third-party either by the proposing party or by the authorizing party, and either in conjunction with or separately from the proposed e-transaction.

The present invention involves creating and sending a notifying e-mail message to the authorizing party's e-mail address that describes the proposed e-transaction and solicits the authorizing party's review and disposition of the proposed e-transaction. The notifying e-mail to the authorizing party describing the proposed e-transaction may also provide information to assist the authorizing party in disposing of the proposed e-transaction. For example, the e-mail to the authorizing party may include 1) a description of the specific e-goods or e-services sought by the proposing party, 2) an identification of the e-tailer, publisher, artist, group, website or other source of the e-goods or e-services, 3) the cost of each e-good or e-service sought by the proposing party, 4) historical data pertaining to cost and descriptions of proposed or consummated e-transactions by the proposing party, and 5) links to reports of consumer watchdog groups, such as the American Academy of Pediatrics (AAP), Mediascope, Consumers' Digest, Underwriters' Laboratories, and the like, that have reviewed and rated the subject matter of the proposed e-transaction. These and other types of information may be made electronically available to the authorizing party using conveniently arranged features, such as clickable buttons and hyperlinks within the e-mail message directed to the authorizing party for the purpose of seeking authorization of a proposing party's proposed e-transaction. The e-mail to the authorizing party may also provide options other than simple authorization or rejection of the entire proposed e-transaction. The e-mail may provide clickable options for the authorizing party's selective authorization of only a subset of the discrete e-transactions making up the originally proposed e-transaction. For example, the authorizing party may reject one objectionable compact disc of five selected by the proposing party, and the authorizing party may thereby authorize an alternative e-transaction comprising the purchase of the remaining four compact discs.

Another embodiment of the present invention utilizes the internet and existing e-mail systems to provide the authorizing party with a customizable information profile regarding the proposed e-transaction. The authorizing party may design her own profile by selecting certain preferred consumer watchdog groups that provide ratings of, for example, rock music, contemporary literature or video movies, or the authorizing party may choose to “pre-enter” their own e-mail contact information, optionally store credit card information, and the like.

Another embodiment of the present invention provides for redundant authorizations from two or more authorizing parties to enable the proposed e-transaction. This embodiment can be used where, for example, the consent of both parents may be required to complete an e-transaction proposed by the proposing minor child.

The foregoing and other objects, features and advantages of the invention will be apparent from the following more particular description of a preferred embodiment of the invention, as illustrated in the accompanying flowcharts.

### BRIEF DESCRIPTION OF THE DRAWINGS

FIG. 1 is a structural diagram of a distributed data processing system illustrating the relationship of an e-content server with a proposing party and an authorizing party using the internet.

FIG. 2 is a structural diagram of a typical user's system communicating with a server system to access e-content located on the e-content server according to the present invention.

FIG. 3 is an example of a typical user's computer system with which the present invention may be implemented.

FIG. 4 is a flowchart of a method that may be executed on the system of FIG. 1 and with the computer system of FIG. 3 in accordance with the present invention.

FIG. 5 is a flowchart of a method that may be executed on the system of FIG. 1 and with the computer system of FIG. 3 in accordance with the present invention.

FIG. 6 is a flowchart of a method that may be executed on the system of FIG. 1 and with the computer system of FIG. 3 in accordance with the present invention.

FIG. 7 is a flowchart of a method that may be executed on the system of FIG. 1 and with the computer system of FIG. 3 in accordance with the present invention.

FIG. 8 is a flowchart of a method that may be executed on the system of FIG. 1 and with the computer system of FIG. 3 in accordance with the present invention.

### DETAILED DESCRIPTION

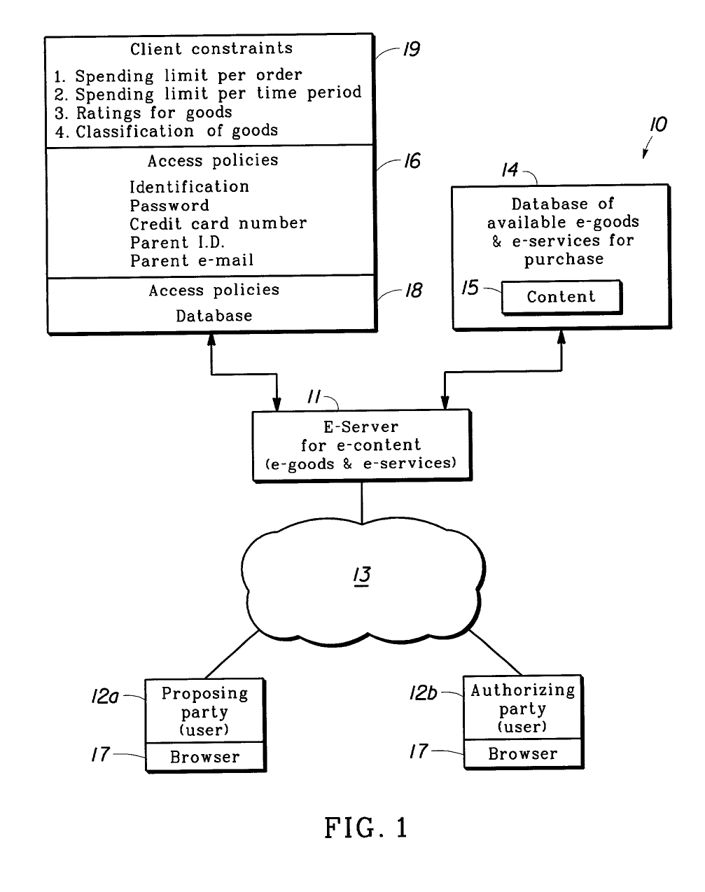

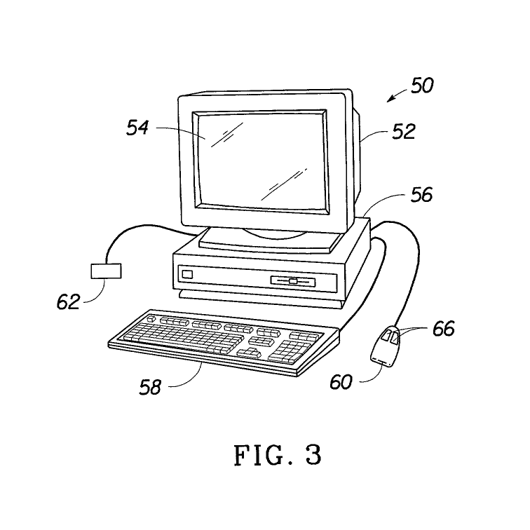

FIG. 1 is a structural diagram of a distributed data processing system 10 illustrating the relationship of an e-content server 11 with multiple e-content consumers workstations 12a, 12b for communication over a communications system or network 13, such as the Internet, an intranet or other network system. As illustrated, the user at the consumers workstation 12, such as a minors workstation 12a, can obtain access over the computer network 13 to an e-content record 15 located in a database 14 on, or available to, the server 11 through the user's web browser 17. The e-content server 11 of the present invention may be a Web Application Server (WAS), a server application, or a server process, where the server includes e-content access policies 16 and an e-content accounting database 18 containing instructions for handling econtent. The e-content server 11 is also in communication with a database 19 of transaction authorization codes unique to certain authorizing parties and useful for enabling a variety of e-commerce transactions, or e-transactions. The web server 11 preferably generates a graphical user interface that is displayed by the browser 17 providing the individual options to the user. A preferred e-content user system 12 is shown in more detail in FIG. 3.

Optionally, a proposing party uses a workstation 12 to access the internet to peruse goods and services available for purchase by a consumer using the internet, and upon deciding on certain desired goods or services, the proposing party 12a submits a proposed e-transaction along with required user information identifying both the individual that is proposing the e-transaction and an e-mail address for an authorizing party at workstation 12b with authority to execute the minor's proposed e-transactions. The information submitted by the proposing party along with the proposed e-transaction can include data such as a password or a combination of a user identification and password assigned by the server 11, or a message to the authorizing party explaining the need or desire for selected items involved in the proposed e-transaction.

Network 13 is the medium used to provide communications links between various devices and computers connected together within the distributed data processing system 10. Network 13 may include permanent connections, such as wire or fiber optic cables, or temporary connections made through telephone or wireless communications. Users and servers may be represented by a variety of computing devices, such as mainframes, personal computers, personal digital assistants (PDAs), smart phones, etc. Distributed data processing system may include additional servers, users, routers and other devices not shown. In the depicted example, the distributed data processing system 10 may include the Internet with network 13 representing a worldwide collection of networks and gateways that use the TCP/IP suite of protocols to communicate with one another. Of course, the distributed data processing system may also include a number of different types of networks, such as, for example, an intranet, a local area network (LAN), or a wide area network (WAN).

The present invention could be implemented on a variety of hardware platforms and could be implemented in a variety of software environments. A typical operating system may be used to control program execution within the data processing system. Furthermore, although the preferred embodiment described below includes “browsers” at the minor workstation 12a and the authorizing party workstation 12b as the agents that exchange data in the security protocols with the Web Application Server, the agent at the proposing party workstation 12a or the authorizing party workstation 12b does not have to be a conventional browser, e.g., Netscape Navigator® or Microsoft Internet Explorer®. In order to secure the information transmitted to and from the server, the minor workstation 12a or the authorizing party workstation 12b may be capable of Public Key Infrastructure (PKI) technology exchanged in a security protocol such as the Secure Sockets Layer (SSL) version 3.0 and above.

Web application server 11 includes a conventional server software program, such as International Business Machines' Websphere®, for administering operation of the server. The server software includes application programs that enable the server 11 to manage the database of e-goods and e-services 14, execute e-content access policies 16, and maintain the accounting database 18.

It should be recognized that the present invention may be implemented over communication systems that include fiber optics, wire or wireless technology, such as Wireless Application Protocol (“WAP”) or Bluetooth based communication mechanisms, or combinations thereof.

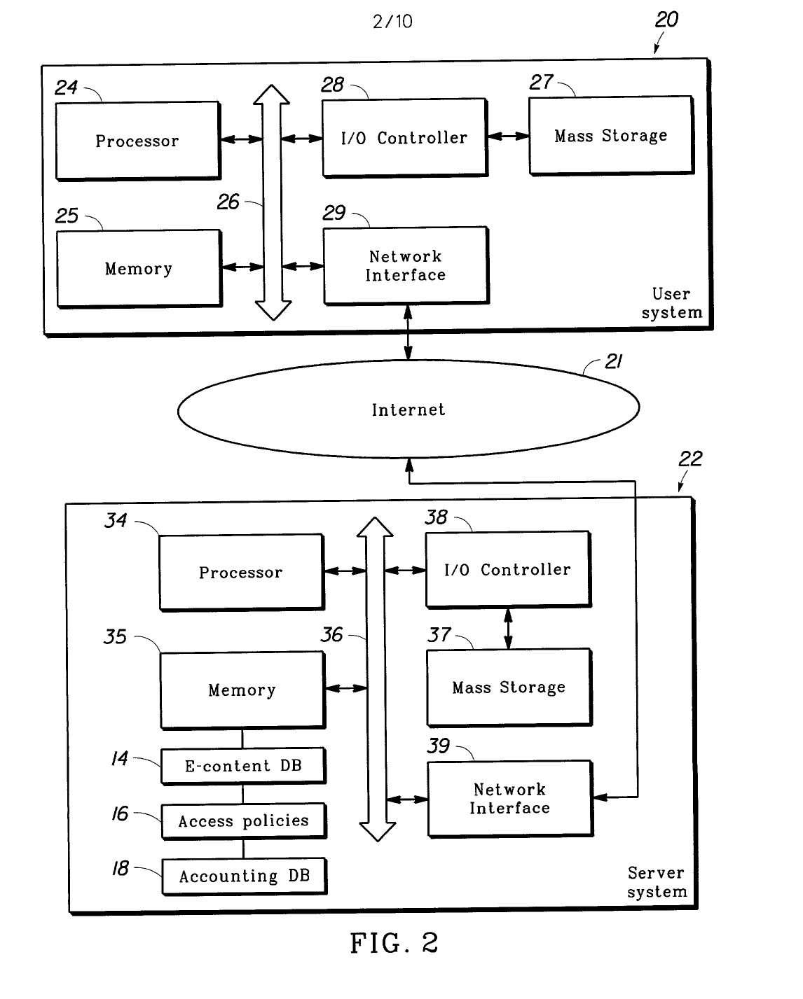

FIG. 2 is a schematic diagram of a typical proposing party's workstation or a typical authorizing party's workstation (both “users”) connected to a server through the Internet 21. For purposes of describing this typical system, the term “user” is used to describe either the proposing party workstation 12a or the authorizing party workstation 12b. In this example, user system 20 is connected through the Internet to remote server system 22. The user system 20 includes conventional components such as a processor 24, memory 25 (e.g. RAM), a bus 26, a mass storage device 27 (e.g. a magnetic hard disk or an optical storage disk) coupled to the bus through an I/O controller 28 and a network interface 29, such as a router. The server system 22 also includes conventional components such as a processor 34, memory 35 (e.g. RAM), a bus 36, a mass storage device 37 (e.g. a magnetic or optical disk) coupled to the bus through an I/O controller 38 and a network interface 39, such as a conventional modem. It will be appreciated from the description below that the present invention may be implemented in software that is stored as executable instructions on a computer readable medium on the user and server systems, such as mass storage devices 27 and 37 respectively, or in memories 25 and 35 respectively. The server system 22 is shown having the e-content database 14, access polices 16, and accounting database 18 stored in memory 35. The server 22 also preferably includes electronic mail software for processing e-mail messages and storing e-mail messages transmitted between the server and the users.

The server and systems shown in FIG. 1 and FIG. 2 are suitable for distributing of econtent, receiving proposed e-transactions and an e-mail address of an authorizing party 12b from the proposing party 12a, creating and sending e-mail to the authorizing party 12b and receiving an e-mail reply from the authorizing party 12b.

FIG. 3 shows a typical user's computer system 50 that can run a browser and with which the present invention may be implemented. The computer system 50 includes a display device 52 (such as a monitor), a display screen 54, a cabinet 56 (which encloses components typically found in a computer, such as CPU, RAM, ROM, video card, hard drive, sound card, serial ports, etc.), a keyboard 58, a mouse 60 and a modem or Ethernet card 62. Mouse 60 may have one or more buttons or control devices, such as buttons 66. The computer requires some type of communication device such as modem or Ethernet network cards 62 that allows computer system 50 to be connected to the Internet.

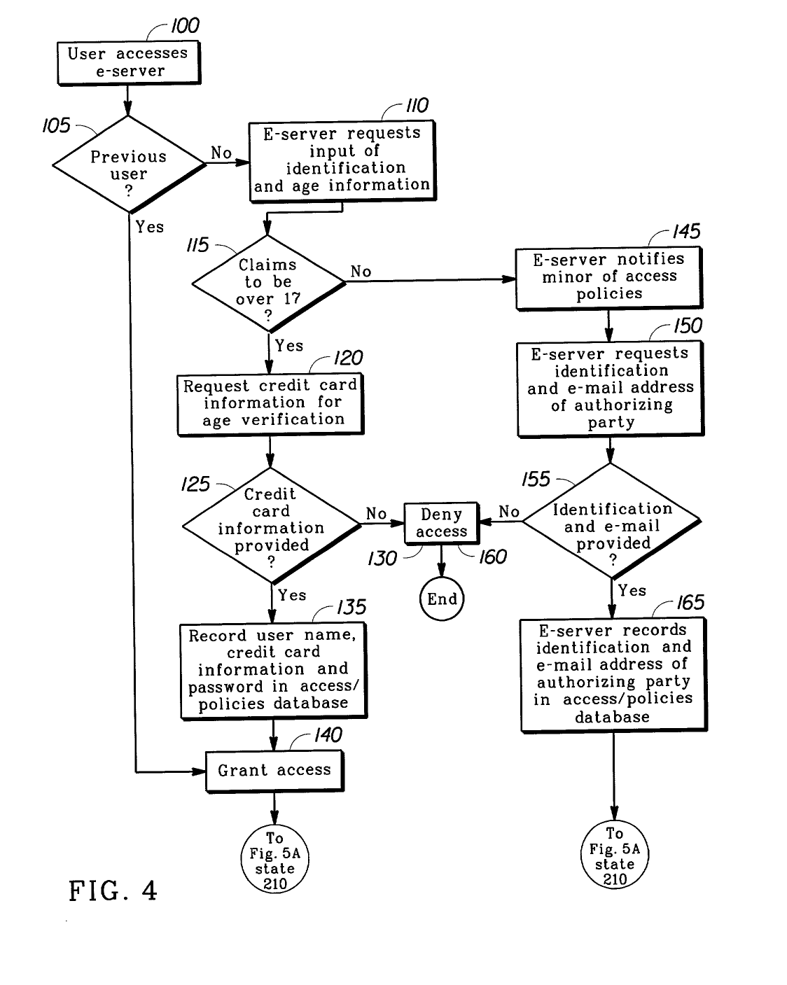

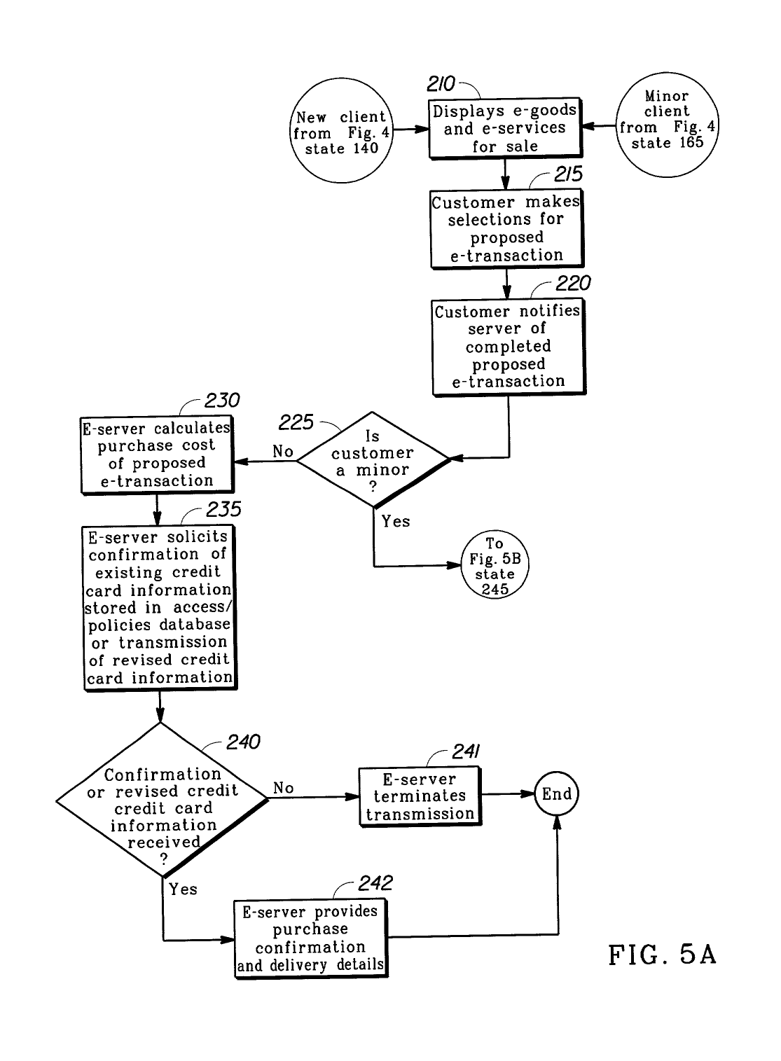

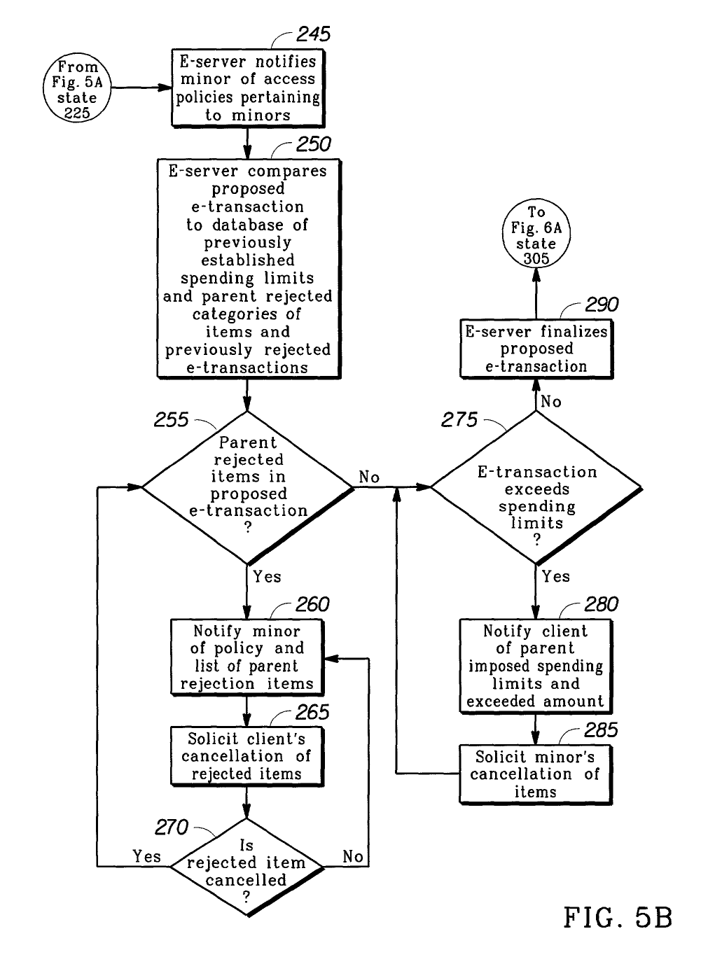

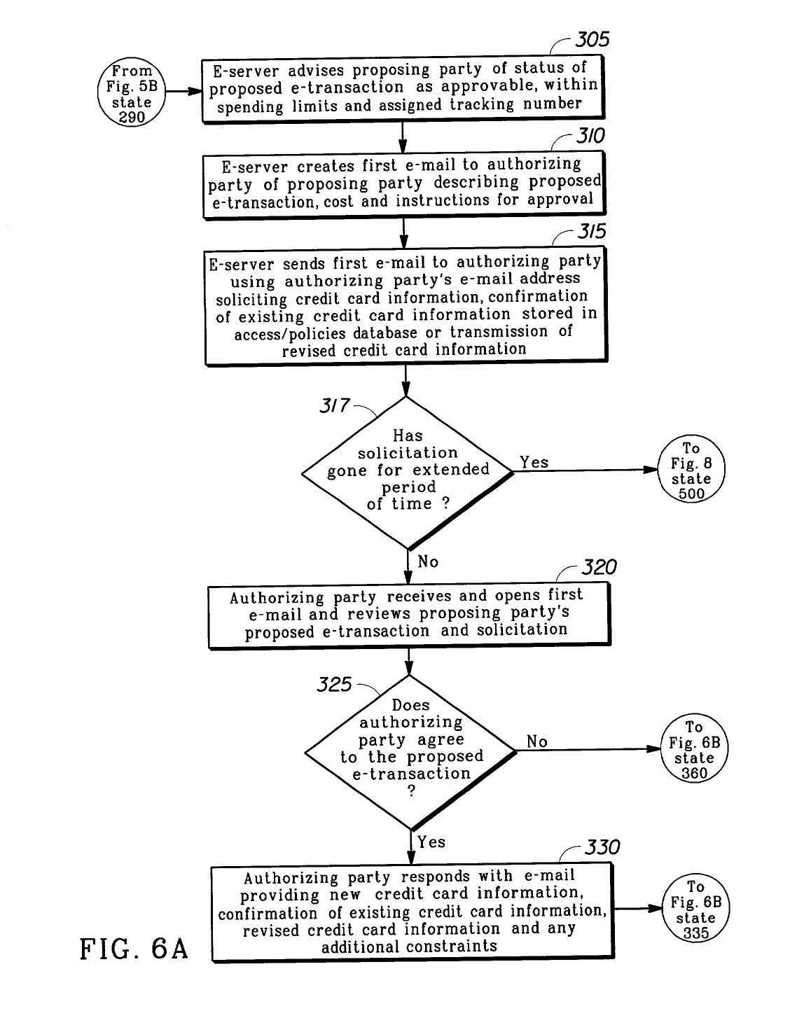

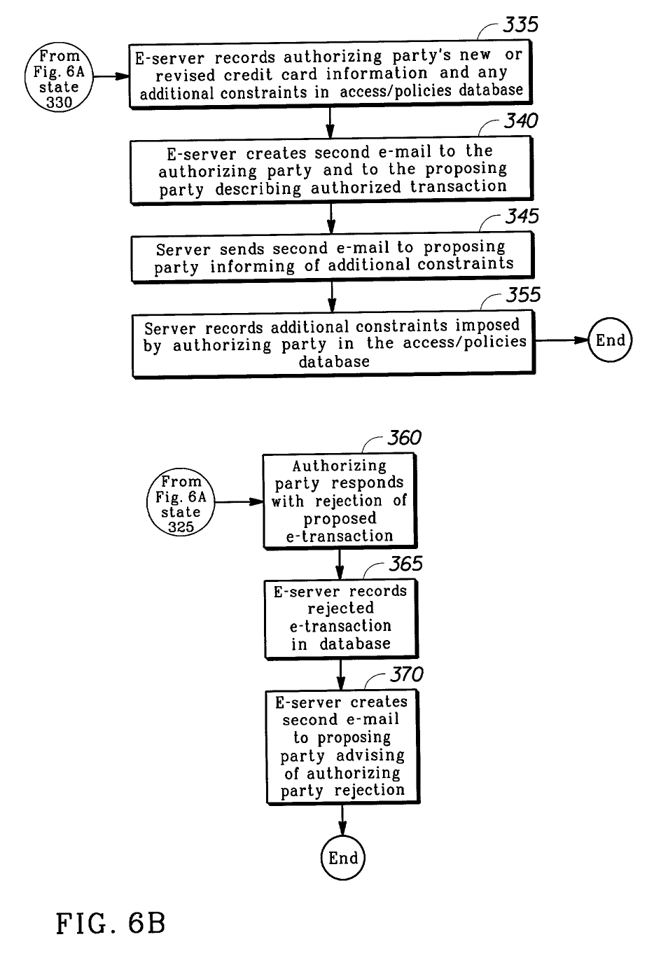

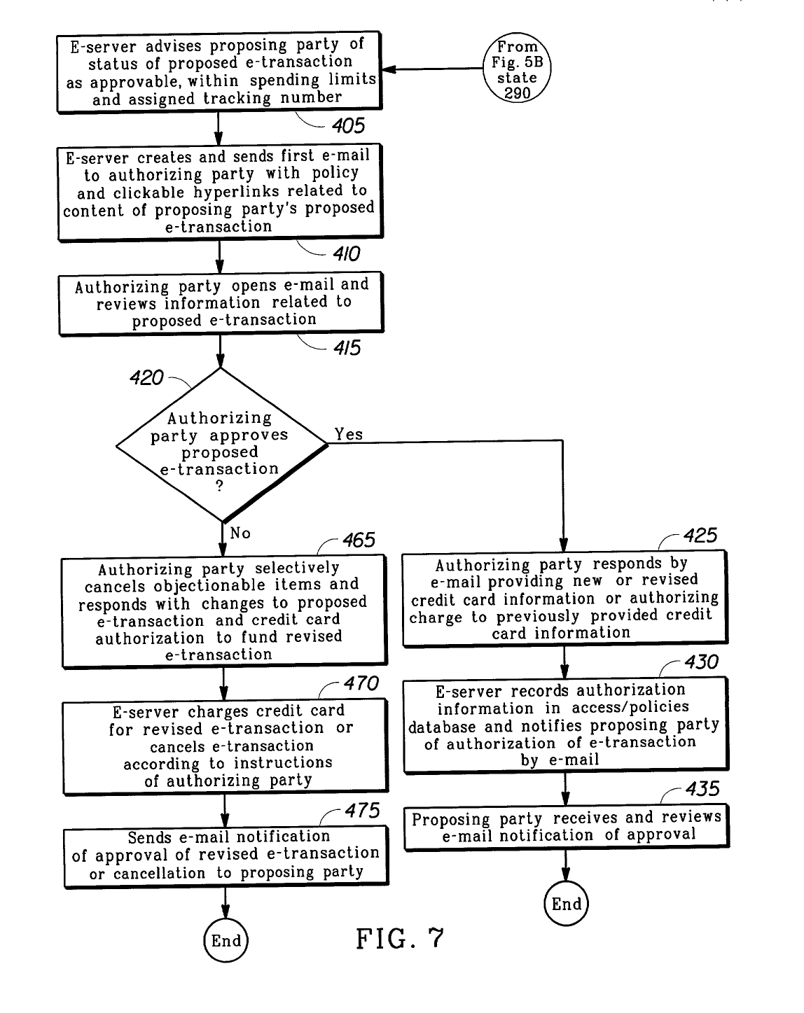

FIG. 4 is a flow chart of a method that may be executed on the system of FIG. 1 and with the computer system of FIG. 3. The method includes an e-server's response to a user accessing the e-server for the first time. In state 100, the user (not yet known to be a minor) accesses the e-server through the Internet and in state 105, the e-server queries whether the user is a previous user. This may be accomplished, for example, with the e-server asking for a user name and password. If, in state 105, the user is determined to be a previous user then, in state 140, the method proceeds to FIG. 5, state 210. If, in state 105 the user is a first time user without a recorded user name and password, then in state 110, the e-server requests for the user's identification and age. If, in state 115, the user claims to be of majority age or otherwise requires no third party authority to make a purchase then, in state 120, the e-server requests a credit card number for verification of majority age. If, in state 125, no credit card number is provided, then in state 130, the e-server denies access to the user. If, in state 125, a credit card number is provided then, in state 135, the e-server provides the new user with a personal password and records the user's credit card number, password and user name in the access/policies database and, in state 140, grants access to allow the user to purchase goods and services. The method then continues as shown in state 210 of FIG. 5.

If, in state 115 the user states he or she is of minority age or states that additional authorization is required then, in state 145, the e-server informs the minor of the access policies. In state 150, the e-server requests an identification and e-mail address for the minor's parent, guardian or other authorizing party. If, in state 155, an identity and an e-mail address is not supplied then, in state 160, access to the e-server is denied. If, in state 155, an authorizing party's e-mail address is supplied, then in state 165, the identity and e-mail address of the authorizing party is recorded in the access/policies database, and then the method continues as shown in FIG. 5, state 210.

FIG. 5 is a flow chart of a method that may be executed on the system of FIG. 1 and with the computer system of FIG. 3. The method includes the e-server's response to a previous customer accessing the e-server and the notification to an authorizing party of a proposing party's e-transaction request. In FIG. 5, state 210, a previous customer from FIG. 4, state 165 is admitted. Alternately, in FIG. 5, state 210, a new customer from FIG. 4, state 140, is admitted. In state 210, the e-server accesses the database of e-goods and e-services available for purchase and displays them to the customer. In state 215, the customer selects e-goods and e-services for proposed purchase and, in state 220, notifies the e-server that the purchase proposal is completed. In state 225, the e-server accesses the access/policies database and determines if the customer is a minor subject to authorization by an authorizing party. If, in state 225 the customer is not a minor or otherwise subject to authorization by an authorizing party then, in state 230, the e-server confirms the total cost of the customer's proposed e-transaction and, in state 235, solicits the non-minor customer's revised credit card information. The customer enables the proposed e-transaction by either confirming the use of existing credit card information stored in the access/policies database or by submission of revised credit card information in response to the e-server's solicitation in state 235. If, in state 240, the e-server receives the customer's confirmation or revised credit card information then, in state 242, the e-server completes the e-transaction and provides purchase confirmation and delivery details to the customer. In the event that proper confirmation or revised credit card information is not received from customer in state 240 in response to the solicitation by the e-server in state 235, then the e-server terminates the e-transaction with the customer in state 241.

If, in state 225, the customer is determined by the e-server to be a minor or someone subject to authorization by an authorizing party then, in state 245, the e-server notifies the minor of the access policies for minors. In state 250, the e-server determines whether all of the proposing party's e-goods and e-services making up the proposed e-transaction are within authorizing party's approved categories recorded in the access/policies database. If, in state 255, the proposed e-transaction is determined to include items within the authorizing party's rejected categories and items then, in state 260, the proposing party is notified of which items were authorizing party rejected, and the method proceeds to state 265 where the proposing party's cancellation of unapproved items from the proposed e-transaction is sought. If, in state 270, all the items are within authorizing party-approved categories, then in state 275, the e-server determines if the total cost of the remaining items exceeds the authorizing party's imposed spending limits recorded in the access/policies database. If, in state 275, the authorizing party-approved spending limit would be exceeded by the proposing party's proposed e-transaction then, the e-server notifies the proposing party of the exceeded amount in state 280 and, in state 285, requests the proposing party to reduce the cost of the proposed e-transaction request by canceling certain items. In response to state 285, the proposing party cancels items and then, in state 275, the e-server again determines whether the total cost of the revised e-transaction items exceeds any recorded authorizing party-imposed spending limits, and the method repeats states 275 through 285 until the total cost of the proposing party's proposed e-transaction is within the recorded spending limit set by the authorizing party. If, in state 275 the total cost does not exceed the recorded spending limit set by the authorizing party then, in state 290, the e-server finalizes the minor's proposed e-transaction and, in FIG. 6, state 305, the e-server provides the proposing party with a transaction record number for tracking the status of the proposed e-transaction. At this point, the proposing party may exit the system or continue to browse and propose further e-transactions.

FIG. 6 is a flow chart of a method that may be executed on the system of FIG. 1 and with the computer system of FIG. 3. The method includes the e-server notifying an authorizing party of the proposing party's request for approval of the proposed e-transaction. From the method shown in FIG. 4, state 165, a proposing party has already provided the e-server with an authorizing party identification and e-mail address for the e-server to use in seeking approval for the proposed e-transaction. The e-server continues from state 290 in FIG. 5 and, in FIG. 6, state 305, the e-server creates a confirming e-mail to the proposing party advising the proposing party of the approvable status of the proposed e-transaction and the assigned tracking number for the proposed e-transaction. In state 310, the server creates a first e-mail to the authorizing party describing the proposed e-transaction and soliciting the authorizing party's approval. In state 315, the server sends the first e-mail to the authorizing party using the authorizing party's e-mail address either provided by the proposing party at state 155 of FIG. 4 or previously provided by the authorizing party and recorded in the access/policies database. In state 320, the authorizing party opens the first e-mail describing the proposing party's proposed e-transaction and reads the proposed e-transaction price, policies, etc. If, in state 325, the authorizing party does not agree to the proposed e-transaction then, in state 360, the authorizing party responds to the e-mail by rejecting approval for the e-transaction proposed by the proposing party. In state 365, the e-server records the authorizing party's rejection in the access/policies database and then, in state 370, creates a first e-mail to the proposing party referencing the previously e-mailed tracking number and notifying the proposing party of the authorizing party's rejection of the proposed e-transaction. If, in state 325, the authorizing party agrees to fund the e-transaction proposed by the proposing party, then in state 330, the authorizing party responds to the e-servers e-mail with credit card information and, optionally, any additional constraints on future e-transactions by the proposing party. In state 335 these authorizing party-imposed constraints are recorded by the e-server in the access/policies database for future reference. These authorizing party-imposed constraints could be, for example, exclusion of certain artists, publishers, ratings on videos or CD's (e.g., G, PG, PG-13, R), monthly spending limits, single transaction spending limits, or constraints by category (e.g., books, clothing, audio, video) of e-goods or e-services which may be purchased by the proposing party. Also, in state 335 the e-server records the credit card information. In state 340, the e-server creates a second e-mail addressed to both the authorizing party and to the proposing party describing the e-transaction authorized and enabled by the authorizing party. In state 345, the e-server creates the second e-mail to the proposing party stating that future authorizing party-approval will be subject to the additional constraints, if any, imposed by the authorizing party. If, in state 325, the authorizing party chooses not to approve the proposing party's proposed transaction, then the proposing party may again access the website at a later time and be recognized by the e-server as a previous customer. If the proposing party chooses to access the website at a later time, the customer signs on as a previous customer as shown in state 190 of FIG. 4.

Optionally, FIG. 7 is a flow chart of a method that may be executed on the system of FIG. 1 and with the computer system of FIG. 3. The method includes an investigative and selective approval process of a proposing party's proposed e-transaction. In state 405, the e-server has finalized a proposing party's proposed e-transaction by the method shown in FIG. 5. In state 410, the e-server sends a customizable first e-mail to the authorizing party detailing the proposing party's proposed e-transaction, showing ratings or reviews by others of the artists, publishers, content or characteristics of the e-goods or e-services requested by the proposing party and may provide clickable hyperlinks to other websites where more detailed information about the e-goods or e-services may be obtained, either for free or at a cost. In state 415, the authorizing party opens the first e-mail, investigates the proposing party's proposed e-transaction, and may review information provided by the e-server in the e-mail or the authorizing party may use hyperlinks to obtain additional review or information about the e-goods or e-services sought by the proposing party. If, in state 420, the authorizing party approves the e-transaction then, in state 425, the authorizing party responds to the e-mail by either providing new or revised credit and information or by confirming authorization to charge the cost of the approved e-transaction to a credit card previously provided by the authorizing party and recorded in the access policies database. In state 430, the e-server receives and records the authorizing party's credit card information and notifies the proposing party of the authorizing party's authorization by e-mail.

If, in state 420, the authorizing party disapproves of the proposed e-transaction, then, in state 465, the authorizing party creates and sends a responsive e-mail selectively canceling objectionable items or rejecting the entire proposed e-transaction, and providing credit card authorization to fund revised e-transaction. In state 470, the e-server modifies the proposing party's proposed e-transaction to conform to the authorizing party's instructions and in state 475, creates and sends an e-mail to the proposing party listing those items approved by the authorizing party, if any.

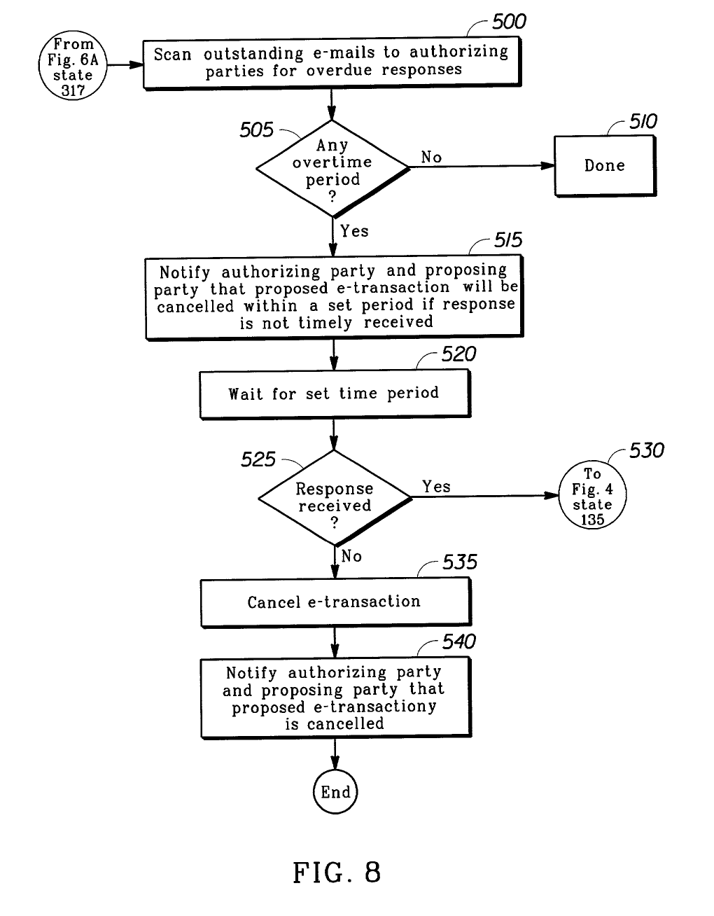

FIG. 8 is a flow chart of a method that may be executed on the system of FIG. 1 and with the computer system of FIG. 3. The method includes a notification process for authorizing parties not having responded in a set time period to the e-server's e-mail requesting approval of a proposing party's proposed purchase. In state 500, the e-server scans the e-mails sent in FIG. 6, state 315 or, alternatively, in FIG. 7, state 415, to determine if any requests for authorization are older than a selected input time period. If, in state 505, there are no outstanding e-mail requests older than the set time period then, in state 510, the method ends. If, in state 505 there are outstanding e-mail requests older than the input time period then, in state 515, the e-server creates and sends an e-mail to the authorizing party notifying the authorizing party and proposing party of the outstanding request for approval and giving a time period that, if no response is received, will result in the automatic cancellation of the proposed e-transaction. State 550 provides a waiting period before taking further action on the failure to respond. In state 525, the e-server determines whether it has received the authorizing party's response to the proposed e-transaction. If it has not received the authorizing party's timely responses then, in state 535, the proposed e-transaction is canceled and, in state 540, an e-mail is created and sent notifying the authorizing party and proposing party of the cancellation of the proposed e- for lack of timely authorization. If in state 525, the e-server determines that a response has been received, the process continues to FIG. 4, state 135.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method for a server to obtain parent authorization of minor-proposed e-transactions comprising:
electronically receiving an e-transaction proposal from the minor;
automatically creating and electronically transmitting a first message to the parent, the message describing the e-transaction proposal and soliciting the parent to enter a transaction authorization code to enable consummation of the proposed e-transaction;
electronically receiving a reply message from the parent providing a transaction authorization code and e-transaction instructions; and
automatically executing the e-transaction instructions.

2. The method of claim 1, further comprising creating and sending an electronically transmittable third message notifying the minor of the parent's response to the proposed e-transaction.

3. The method of claim 1, wherein the reply message comprises a credit card number for electronically funding the minor's proposed e-transaction.

4. The method of claim 1, wherein the reply message comprises a server-verifiable transaction authorization code.

5. The method of claim 1, wherein the reply message comprises a transaction specific code.

6. The method of claim 1, wherein the first message is an e-mail addressed to the parent's e-mail address.

7. The method of claim 1, wherein the parent's e-mail address is provided by the minor along with the proposed e-transaction.

8. The method of claim 1, wherein the parent's e-mail address is available from an accessible database.

9. The method of claim 8, wherein the parent's e-mail address is provided by the parent prior to the server's receipt of the minor's proposed e-transaction.

10. The method of claim 1, wherein the first message to the parent provides clickable options to approve the proposed e-transaction and to reject the proposed e-transaction.

11. The method of claim 1, wherein the first message to the parent lists each item sought by the minor in proposing the e-transaction and provides clickable options to selectively reject discrete items of the proposed e-transaction.

12. The method of claim 1, wherein the first message comprises clickable options for providing the parent's reasons for rejecting items from the proposed e-transaction.

13. The methods of claim 1, wherein the proposed e-transaction involves the purchase of goods, and wherein the first e-mail message comprises information related to content of the goods involved in the proposed e-transaction.

14. The method of claim 1, wherein the first messages provide clickable hyperlinks enabling the parent to access reviews by others of the goods sought in the e-transaction proposal.

15. A method for a server to provide a parent with control over an e-transaction proposed by a minor comprising:
electronically receiving a proposed e-transaction from a minor;
receiving an e-mail address of the minor's parent;
creating an electronically transmittable message addressed to the parent's e-mail address;
electronically providing the parent with a description of the proposed e-transaction;
electronically receiving a reply message from the parent comprising the parent's instructions regarding the proposed e-transaction;
disposing of the proposed e-transaction in accordance with the parent's instructions; and
electronically notifying the minor of the parent's instructions regarding the proposed e-transaction proposed by the minor.

16. A computer program product including instructions embodied on a computer readable medium, the instructions comprising:
instructions for receiving an e-transaction proposal from a minor;
instructions for automatically creating and electronically transmitting a first message to a parent, the message describing the e-transaction proposal and soliciting the parent to enter a transaction authorization code to enable consummation of the proposed e-transaction;
instructions for receiving a reply message from the parent providing a transaction authorization code and e-transaction instructions; and
instructions for executing the e-transaction instructions.

17. The computer program product of claim 16, further comprising:
instructions for creating and sending an electronically transmittable third message notifying the minor of the parent's response to the proposed e-transaction.

18. The computer program product of claim 16, wherein the reply message comprises a credit card number for electronically funding the minor's proposed e-transaction.

19. The computer program product of claim 16, wherein the reply message comprises a server-verifiable transaction authorization code.

20. The computer program product of claim 16, wherein the reply message comprises a transaction specific code.

21. The computer program product of claim 16, wherein the first message is an e-mail message addressed to the parent's e-mail address.

22. The computer program product of claim 21, wherein the parent's e-mail address is provided by the minor along with the proposed e-transaction.

23. The computer program product of claim 21, wherein the parent's e-mail address is available from an accessible database.

24. The computer program product of claim 23, wherein the parent's e-mail address is provided by the parent prior to the server's receipt of the minor's proposed e-transaction.

25. The computer program product of claim 21, wherein the first message to the parent provides clickable options to approve the proposed e-transaction and to reject the proposed e-transaction.

26. A computer system for obtaining parent authorization of minor-proposed e-transactions comprising:
first receiving means for electronically receiving an e-transaction proposal from the minor;
messaging means for automatically creating and electronically transmitting a first message to the parent, wherein the message describes the e-transaction proposal and solicits the parent to enter a transaction authorization code to enable consummation of the proposed e-transaction;
second receiving means for electronically receiving a reply message from the parent providing a transaction authorization code and e-transaction instructions; and
executing instructions for automatically executing the e-transaction instructions.

27. The computer system of claim 26, further comprising:
notification means for creating and sending an electronically transmittable third message notifying the minor of the parent's response to the proposed e-transaction.

28. The computer system of claim 26, wherein the reply message comprises a credit card number for electronically funding the minor's proposed e-transaction.

29. The computer system of claim 26, wherein the reply message comprises a server-verifiable transaction authorization code.

30. The computer system of claim 26, wherein the reply message comprises a transaction specific code.

31. The computer system of claim 26, wherein the first message is an e-mail message addressed to the parent's e-mail address.

32. The computer system of claim 26, further comprising:
submission means for allowing the minor to submit the parent's e-mail address along with the proposed e-transaction.

33. The computer system of claim 26, wherein the parent's e-mail address is available from an accessible database.

34. The computer system of claim 33, further comprising:
submission means for allowing the parent to submit the parent's e-mail address prior to receiving the minor's proposed e-transaction.

35. The computer system of claim 26, further comprising:
approval means for allowing the parent to approve or reject the proposed e-transaction through clickable options provided in the first message.

36. The computer system of claim 26, further comprising:
approval means for allowing the parent to approve or reject individual items of the proposed e-transaction through clickable options provided in the first message.

37. The computer system of claim 26, wherein the proposed e-transaction involves the purchase of goods, and wherein the first e-mail message comprises information related to content of the goods involved in the proposed e-transaction.

38. The computer system of claim 26, further comprising:
research means for allowing the parent to research reviews of the good sought in the e-transaction proposal through clickable hyperlinks provided in the first message.
